(19) United States
(12) Patent Application Publication
(10) Pub. No.: US 2002/0130738 A1
(43) Pub. Date: Sep. 19, 2002

(54) Dielectric filter, dielectric duplexer, and communication apparatus using the same

(76) Inventors: Jun Toda, Ishikawa-ken (JP); Motoharu Hiroshima, Ishikawa-ken (JP); Hideyuki Kato, Ishikawa-ken (JP)

Correspondence Address: DICKSTEIN SHAPIRO MORIN & OSHINSKY LLP, Steven I. Weisburd, 41st Floor, 1177 Avenue of the Americas, New York, NY, 10036-2714, US

(21) Appl. No.: 10/097,243

(22) Filed: Mar. 15, 2002

(30) Foreign Application Priority Data
Mar. 15, 2001 (JP) 2001-074841
Jan. 11, 2002 (JP) 2002-004917

(51) Int. Cl. H01P 1/20

(52) U.S. Cl. 333/206

(57) ABSTRACT

A dielectric filter includes a dielectric block having a plurality of a outer surfaces and a plurality of through holes extending through the dielectric block. Inner conductors are located on respective inner surfaces of the through holes and an outer conductor is located on a plurality of the outer surface of the dielectric block. An input-output electrode is formed on at least one of the outer surfaces of the dielectric block and is faced from the outer conductor by first conductor-less portion. A rectangular second conductor-less portion extends from the first conductor-less portion to generate an attenuation pole at a desired frequency positioned at a higher frequency side of the band pass of a transmission signal.

### BACKGROUND OF THE INVENTION

1. Field of the Invention

The present invention relates to dielectric filters, dielectric duplexers using at least one of the dielectric filters, and communication apparatuses using at least one of the dielectric filters.

2. Description of the Related Art

A conventional dielectric filter using an almost rectangular-parallelepiped dielectric block will be described by referring to FIG. 15.

FIG. 15 is a perspective view of the conventional dielectric filter. In this filter a pair of through holes 2a and 2b extend through a dielectric block 1 and a pair of inner conductors 3a and 3b are formed on the inner surfaces of the through holes to form respective resonator cavities. An outer conductor 4, is formed on five of the surfaces of the dielectric block 1. A pair of input-output electrodes 6a and 6b are formed on the outer surfaces of the dielectric block and are separated from the outer conductor 4 by respective conductor-less portions 5a and 5b.

Each of the through holes 2a and 2b has a stepped structure in which the holes are divided into two sections having different inner diameters. One end of each of the through holes 2a and 2b is open circuited and the other end is short-circuited to the outer conductor 4.

This conventional dielectric filter has the following problems.

Each inner conductor forms a TEM-mode resonator in cooperation with the outer conductor and the dielectric block. Each resonator is coupled to the other resonator to form the dielectric filter. An attenuation pole (coupling pole) is generated due to the coupling between the resonators. With the use of this attenuation pole, the attenuation characteristic can be made to have a steep slope between a pass band and a lower-frequency-side cut-off zone, or between the pass band and a higher-frequency-side cut-off zone.

In the dielectric filter in which the outer conductor 4 is formed in such a way on the outer surfaces of the rectangular-parallelepiped dielectric block 1, the dielectric block and the outer conductor generate a resonant mode, such as a TE₁₀₁ mode, other than the TEM mode, which is a basic resonant mode.

FIG. 16 is a view showing the attenuation characteristic of such a dielectric filter. As shown in FIG. 16, the dielectric filter has an attenuation pole A and an attenuation pole B.

The attenuation pole A is an attenuation pole generated by the coupling between the dielectric resonators, that is, an attenuation pole in the TEM mode, which is a basic resonant mode, and its frequency can be specified by the distance between the resonators and the diameter of the holes for forming inner conductors. In this example, the resonators are capacitively coupled to form an attenuation pole at a lower-frequency side of the pass band.

In contrast, the attenuation pole B is generated by a resonant mode, such as the TE mode described above, other than the basic mode, and its frequency depends on the external dimensions of the dielectric block, not (to any significant degree) on the distance between the resonators and the diameter of the holes for forming inner conductors. Therefore, the dimensions and shape of the dielectric block can be determined to specify the frequency of the attenuation pole B.

However, since it is currently demanded that dielectric filters be made compact, there is a restriction on how much the dimensions of the dielectric blocks can be changed to obtain the desired attenuation pole B.

The characteristics of dielectric filters generally cannot be changed after their dielectric blocks and conductive patterns are formed. Therefore, to obtain a dielectric filter having a different characteristic, it is necessary to redesign the whole filter.

In contrast, dielectric filters whose frequency characteristics can be changed are disclosed in (1) Japanese Unexamined Patent Publication No. Hei-10-284903, (2) Japanese Unexamined Patent Publication No. Hei-11-177307, and (3) Japanese Unexamined Patent Publication No. Hei-7-263912.

The dielectric filter disclosed in (1) is formed by connecting coupling electrodes of two dielectric resonators. A partly narrowed portion where an outer conductor is not formed is provided in the vicinity of each of the coupling electrodes to insert an equivalent LC series resonant circuit between the coupling electrode and the ground of the outer conductor, so that the frequency of an attenuation pole is shifted.

The dielectric filter disclosed in (2) is also formed by connecting coupling electrodes of two dielectric resonators. Relatively large portions where an outer conductor is not formed are provided at surfaces opposing each other of the two dielectric resonators to make the two dielectric resonators form M-type coupling, so that the frequency of an attenuation pole is shifted.

In the dielectric filters of (1) and (2), the shapes of the portions where the outer conductors are not formed, which are close to the coupling electrodes, are changed to change the degree of coupling between the dielectric resonators, so that the attenuation poles are shifted. These attenuation poles correspond to the attenuation pole A shown in FIG. 16, which is an attenuation pole generated in the TEM mode, which is a basic mode. In these filters, each dielectric resonator needs to have a predetermined portion where an outer conductor is not formed, and matching needs to be applied to each resonator. Therefore, it is difficult to perform attenuation-pole adjustment in each dielectric filter.

In the dielectric filter disclosed in (3), a conventional dielectric filter is formed and a portion of the outer conductor is removed by a router in order to obtain a desired coupling characteristic. More specifically, due to this machining, a coupling capacitance between the input-output electrode and a ground electrode is reduced. Consequently, coupling between resonators is increased, the coupling capacitance increases, and an attenuation frequency band in the TEM mode is widened, so that the desired characteristic is obtained.

In this dielectric filter, however, the attenuation pole B in the TE mode, shown in FIG. 16, cannot be shifted, and a spurious-signal characteristic cannot be improved.

### SUMMARY OF THE INVENTION

Accordingly, an object of the present invention is to provide a dielectric filter in which its attenuation characteristic is easily changed without changing its outside dimensions to improve its spurious-signal characteristic. Such a filter can be used in a dielectric duplexer. A communication apparatus can use the dielectric filter or the dielectric duplexer.

The foregoing object is achieved in one aspect of the present invention by a dielectric filter comprising:

a dielectric block having a plurality of outer surfaces and a plurality of through holes extending through the dielectric block;

inner conductors located on respective inner surfaces of the through holes;

an outer conductor located on a plurality of the outer surfaces of the dielectric block;

an input-output electrode formed on at least one of the outer surfaces of the dielectric block, the input-output electrode being spaced from the outer conductor by a first conductor-less portion; and

a rectangular second conductor-less portion extending form the first conductor-less portion to generate an attenuation pole at a desired frequency positioned at a higher-frequency side of the pass band of a transmission signal.

The second conductor-less portion is preferably rectangular extended portion having a narrow strip shape and extending in a direction either parallel to or perpendicular to the axes of the through holes.

In both cases, the dielectric filter has a desired attenuation-pole frequency while minimally changing the other filter characteristics.

The outer conductor contacting the rectangular extended portion may be locally removed to form a third (preferably arcuate) conductor-less portion to finely adjust the frequency of the attenuation pole.

The foregoing object is achieved in another aspect of the present invention through the provision of a dielectric duplexer including a dielectric filter described above.

According to the present invention, when a dielectric duplexer includes the dielectric filter, the dielectric duplexer can have a desired characteristic.

The foregoing object is achieved in still another aspect of the present invention through the provision of a communication apparatus including a dielectric filter described above, or the dielectric duplexer described above.

According to the present invention, when a communication apparatus includes a dielectric filter described above or the dielectric duplexer, the communication apparatus can have a predetermined communication performance.

### BRIEF DESCRIPTION OF THE DRAWINGS

FIG. 1 is a perspective view of a dielectric filter according to a first embodiment of the invention.

FIG. 2 is a perspective view of another dielectric filter according to a second embodiment.

FIG. 3 is a perspective view of still another dielectric filter according to a third embodiment.

FIG. 4 is a view showing the attenuation characteristic of a dielectric filter according to the first to third embodiments.

FIG. 5 is a perspective view of a dielectric filter according to a fourth embodiment.

FIG. 6 is a perspective view of a dielectric filter according to a fifth embodiment.

FIG. 7 is a perspective view of a dielectric filter according to a sixth embodiment.

FIG. 8 is a perspective view of a dielectric filter according to a seventh embodiment.

FIG. 9 is a perspective view of a dielectric filter according to a eighth embodiment.

FIG. 10 is a perspective view of a dielectric filter according to the ninth embodiment.

FIG. 11 is a perspective view of a dielectric filter according to a tenth embodiment.

FIG. 12 is a perspective view of a dielectric filter according to an eleventh embodiment.

FIG. 13 is a perspective view of a dielectric duplexer according to the invention.

FIG. 14 is a block diagram of a communication apparatus using the dielectric filter and duplexer of the invention.

FIG. 15 is a perspective view of a conventional dielectric filter.

FIG. 16 is a view showing the attenuation characteristic of the conventional dielectric filter.

### DESCRIPTION OF THE PREFERRED EMBODIMENTS

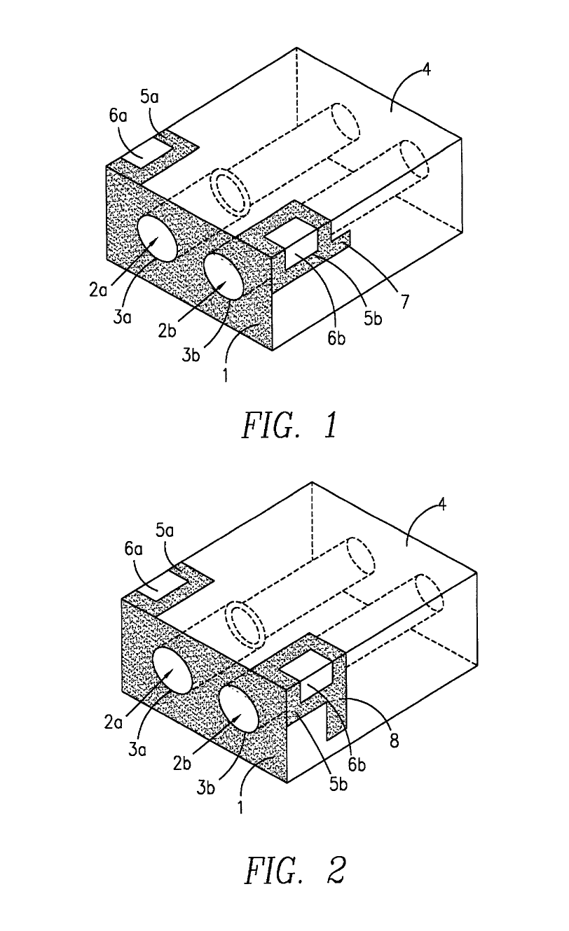

The structure of three closely related dielectric filters constructed according to the principles of the invention will be described below by referring to FIG. 1 to FIG. 3.

In each of these embodiments, a pair of through holes 2a and 2b extend through a rectangular parallelpiped dielectric block from a left-hand surface thereof toward a right-hand surface thereof. An outer conductor 4 is formed on five of the outer surfaces of the dielectric block 1 except the left-hand surface which is an open surface. Each of the through holes 2a and 2b have a stepped shape in which the diameters are larger at the open surface side of the dielectric block 1.

Inner conductors 3a and 3b are formed on the inner surfaces of the through holes 2a and 2b, respectively, to form respective resonant cavities. The resonant cavities are short circuited to the outer conductor 4 at the right-hand surface of the dielectric block 1.

Input-out electrodes 6a and 6b are defined on the outer surfaces of the dielectric block 1 by conductor-less portions 5a and 5b, respectively. Each of the input-output electrodes extends from the mounting surface of the dielectric block (the upper surface in FIGS. 1-3) to respective side surfaces thereof

In each of the embodiments shown in FIGS. 1-3, one or more extended conductor-less portions are formed to extend from the conductor-less portions 5a, 5b to adjust the attenuation characteristics of the filter.

In the embodiment of FIG. 1, a narrow rectangular extended conductor-less portion 7 extends from the conductor-less portion 5b in a direction running parallel to the central axis of the through holes 2a and 2b. In this embodiment, the conductor-less portions 5a and 5b are adjacent the open surface of the dielectric block 1. With such a structure, a dielectric filter having two capacitively coupled resonators is formed.

In the dielectric filter shown in FIG. 2, the conductor-less rectangular extended portion 8 extends perpendicular to the axial director of the through holes 2a and 2b. Except for this point, the dielectric filter shown in FIG. 2 has the same structure as that shown in FIG. 1.

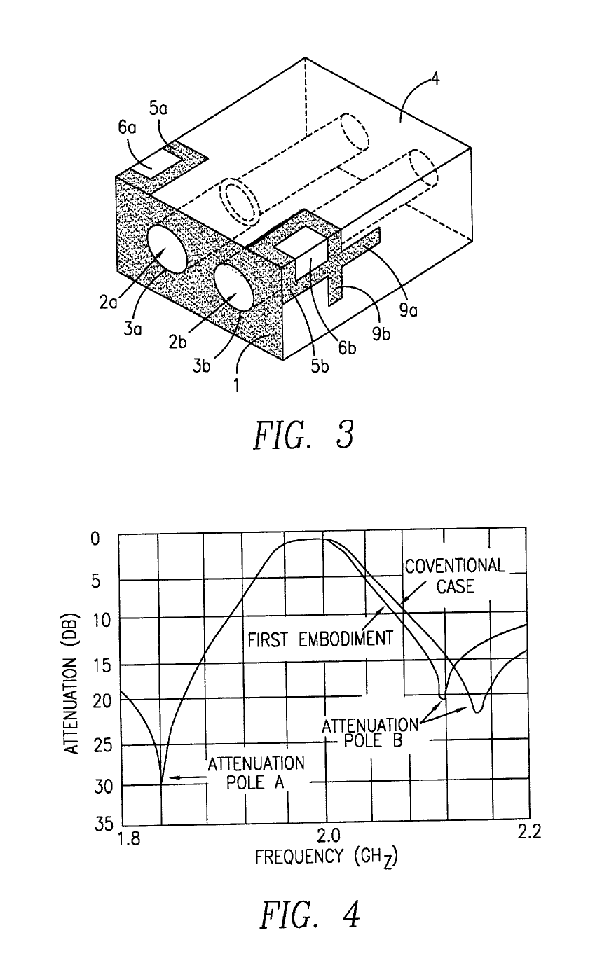

In the dielectric filter shown in FIG. 3, a pair of conductor-less rectangular extended portions 9a and 9b extend from the conductor-less portions 5a and 5b in directions parallel to and perpendicular to, respectively, the axes of the through holes 2a and 2b. Except for this point, the dielectric filter shown in FIG. 3 has the same structure as that shown in FIG. 1.

With such structures, since perturbation occurs in the TE resonant mode caused by the dielectric block 1 and the outer conductor 4, the resonant frequency of the TE mode is reduced, and the frequency of the attenuation pole B, where the TE mode and the TEM mode have opposite phases, is shifted to a lower-frequency side, as shown in FIG. 4. Therefore, the lengths of the conductor-less rectangular extended portions are set to a predetermined distance to obtain a desired attenuation characteristic.

When the size of the conductor-less area 5b is enlarged by the presence of the conductor-less extended portions, the area of the outer conductor 4 is reduced. Therefore, each resonator constituting the dielectric filter has a reduced Q₀ or the resonant frequency f₀ of a resonator close to an input-output electrode increases significantly, so that the characteristic of the dielectric filter deteriorates.

When the conductor-less rectangular extended portion has a narrow-strip shape, the size reduction of the outer conductor 4 is small and the attenuation pole can be adjusted without significantly effecting the characteristic of the dielectric filter (other than the attenuation poles).

The conductor-less rectangular extended portions 7, 8, 9a, and 9b may extend from one or both of the conductor-less portions 5a and 5b.

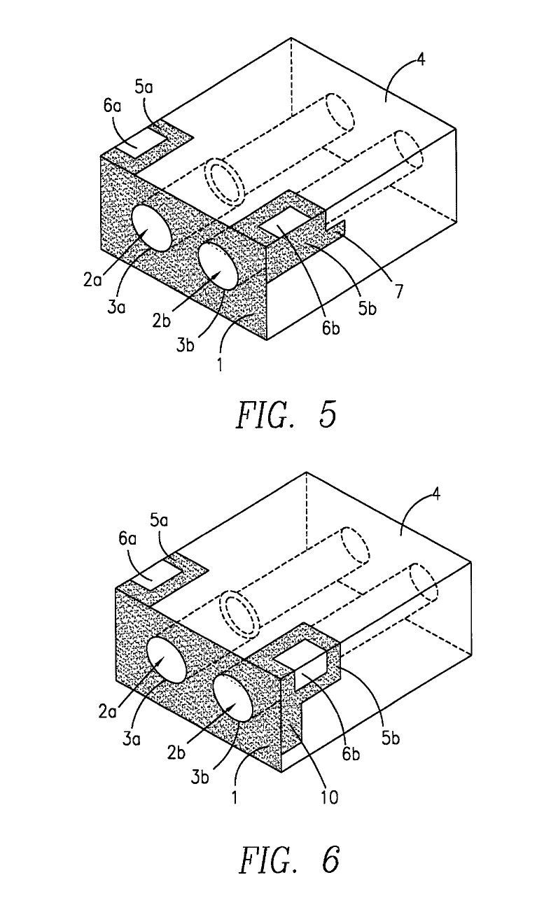

Another embodiment of the invention is shown in FIG. 5. In this embodiment, the input-output electrodes 6a and 6b are formed only on the bottom surface which serves as a mounting surface of the dielectric filter. Except for this point, the dielectric filter shown in FIG. 5 has the same structure as that shown in FIG. 1. As with the prior embodiments, the resonant frequency of the TE mode of this embodiment is reduced, and the same advantage is obtained as in the first embodiment.

In the dielectric filter shown in FIG. 6, the conductor-less rectangular extended portion 10 is provided in contact with the open surface of the dielectric block 1. Except for this point, the dielectric filter shown in FIG. 6 has the same structure as that shown in FIG. 1.

With such a structure, since perturbation occurs in the TE resonant mode caused by the dielectric block 1 and the outer conductor 4, the resonant frequency of the TE mode is reduced and the frequency of the attenuation pole B, where the TE mode and the TEM mode have opposite phases, is shifted to a lower-frequency side, as shown in FIG. 4. Therefore, the length of the conductor-less rectangular extended portion is set to a predetermined distance to obtain a desired attenuation characteristic. The conductor-less rectangular extended portion 10 may extend from one or both of the conductor-less portion 5a and 5b.

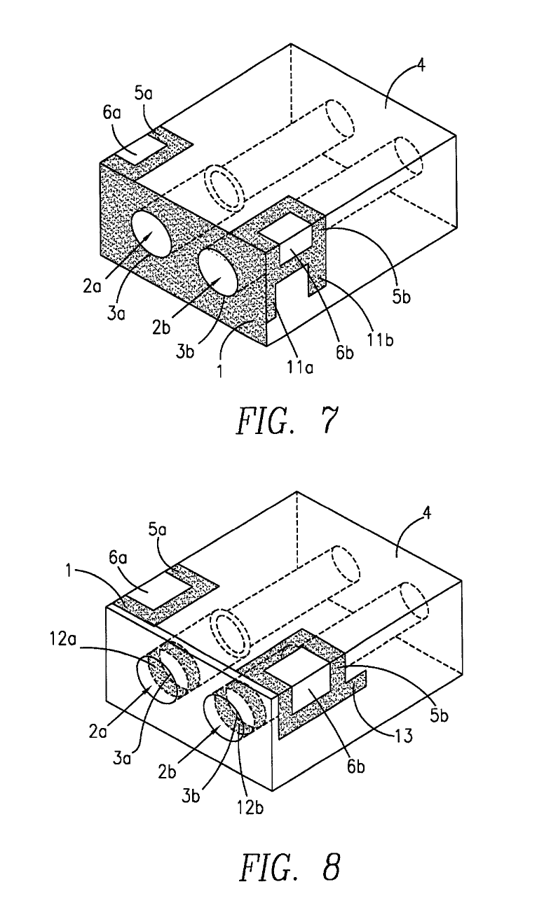

In the dielectric filter shown in FIG. 7, one conductor-less rectangular extended portion 11a is provided in contact with the open surface of a dielectric block 1 and another conductor-less rectangular extended portion 11b is provided at a position spaced from the open surface as in the first embodiment. Except for this point, the dielectric filter shown in FIG. 7 has the same structure as that shown in FIG. 1.

With such a structure, since perturbation occurs in the TE resonant mode caused by the dielectric block 1 and the outer conductor 4, the frequency of the attenuation pole is shifted to a lower-frequency side in the same way as in each of the above-described embodiments. Therefore, the length of the conductor-less rectangular extended portions is set to a predetermined distance to obtain a desired attenuation characteristic. The conductor-less rectangular extended portions 11a and 11b of the portion may extend from one or both of the conductor-less portions 5a and 5b.

The structure of a dielectric filter according to yet another embodiment will be described next by referring to FIG. 8.

In the embodiment of FIG. 8, through holes 2a and 2b extend from a left-hand surface of the dielectric block 1 toward a right-hand surface thereof. Unlike the prior embodiments, the outer conductor 4 is formed on all six of the outer surfaces of the dielectric block 1. However, conductor-less portions 12a and 12b are provided at the inner conductors 3a and 3b to define open ends of the resonator cavities. Like the prior embodiments, the through holes 2a and 2b are stepped holes in which the larger diameter portions are located at the open-end side of the resonator cavities.

Like the embodiment of FIG. 1, the input-output electrodes extend from the mounting surface of the dielectric block 1 to respective end surfaces thereof. The input-output electrodes are defined by conductor-less portions 5a and 5b which separate the input-output electrodes 6a and 6b from the outer conductor 4. The portion 5b where the outer conductor is not formed is partially extended by a predetermined distance in a direction parallel to the axes of the holes 2a and 2b in a narrow-strip manner to form the rectangular extended portion 13. With such a structure, the dielectric filter having two capacitively coupled resonators is formed and the frequency of an attenuation pole is shifted to a lower-frequency side as in each of the above-described embodiments. Respective conductor-less rectangular extended portions may extend from either or both of the conductor-less portions 5a, 5b on the respective end surfaces of the dielectric block 1. If the through holes 2a and 2b are formed as straight holes (i.e., are not stepped), they are inductively coupled and peaks in the TEM mode and the TM mode appear at a higher-frequency side of the pass band.

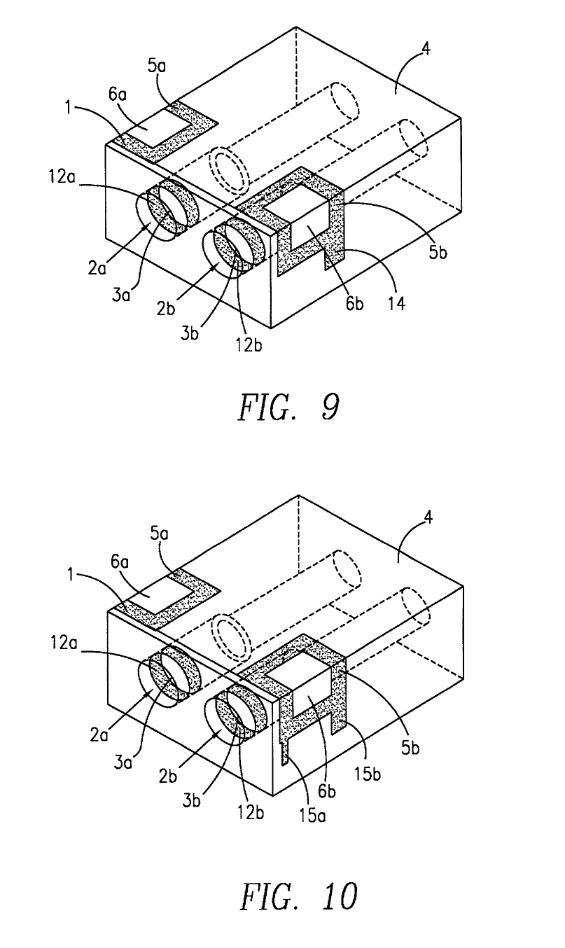

In the dielectric filter shown in FIG. 9, a conductor-less rectangular extended portion 14 extends in a direction perpendicular to the mounting surface of the dielectric block. Except for this point, the dielectric filter shown in FIG. 9 has the same structure as that shown in FIG. 7.

In the dielectric filter shown in FIG. 10, a pair of conductor-less rectangular extended portions 15a and 15b extend perpendicular to the mounting surface. Except for this point, the dielectric filter shown in FIG. 10 has the same structure as that shown in FIG. 7.

With each of these structures, the frequency of an attenuation pole is shifted to a lower-frequency side.

The conductor-less rectangular extended portions 14, 15a, and 15b may extend from either or both conductor-less portions 5a and 5b on the dielectric block 1.

If the through holes 2a and 2b are formed as straight holes (i.e., are not stepped), they are inductively coupled and peaks in the TEM mode and the TM mode appear at a higher-frequency side of the pass band.

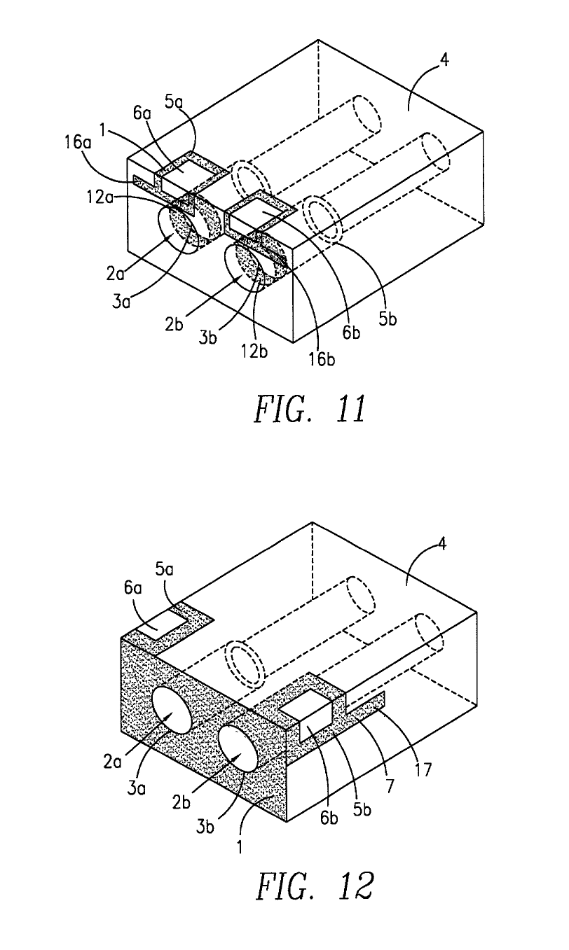

In the embodiment of FIG. 11, through holes 2a and 2b extend from the left-hand, surface of the dielectric block 1 to the right-hand surface thereof. Like the embodiment of FIG. 8, the outer conductor 4 is formed on all six outer surfaces of the dielectric block 1. Conductor-less portions 12a and 12b are provided on the through holes 2a and 2b to define open ends of the resonant cavities.

Unlike the prior embodiments, the input-output electrodes 6a and 6b extend from the mounting surface of the dielectric block 1 (the top surface in the drawing) to the left face thereof. As such, the conductor-less portions 5a and 5b partially extend onto this surface. A narrow conductor-less rectangular extension portion 16a and 16 extends from each of the conductor-less portion 5a and 5b, respectively, by a predetermined distance in a direction in which the holes 2a and 2b are arranged.

With this structure, the frequency of an attenuation pole is shifted to a lower-frequency side. When the through holes 2a and 2b are formed to be straight (i.e., are not stepped), the resonators are inductively coupled and peaks in the TEM mode and the TM mode appear at the higher-frequency side of the pass band.

The dielectric filter shown in FIG. 12 is the same as that shown in FIG. 1, except that it has a further conductor-less portion 17 connected to the distal end of the conductor-less rectangular extended portion 7.

By adjusting the amount of outer conductor 4 removed to create the further conductor-less portion 17, the shift in frequency of an attenuation pole can be finely adjusted. The conductor-less portion 17 may be provided at any position connected to the conductor-less portion 5b and/or the conductor-less rectangular extended portion 7. Therefore, the conductor-less portion 17 is not necessarily made in the vicinity of an input-output electrode, unlike the conventional technology (3), and work for making it is facilitated.

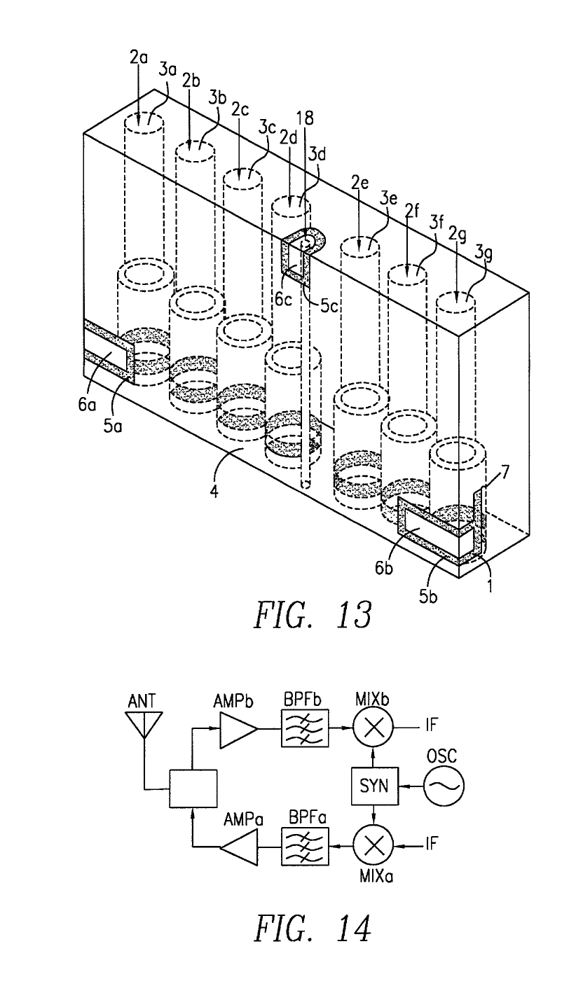

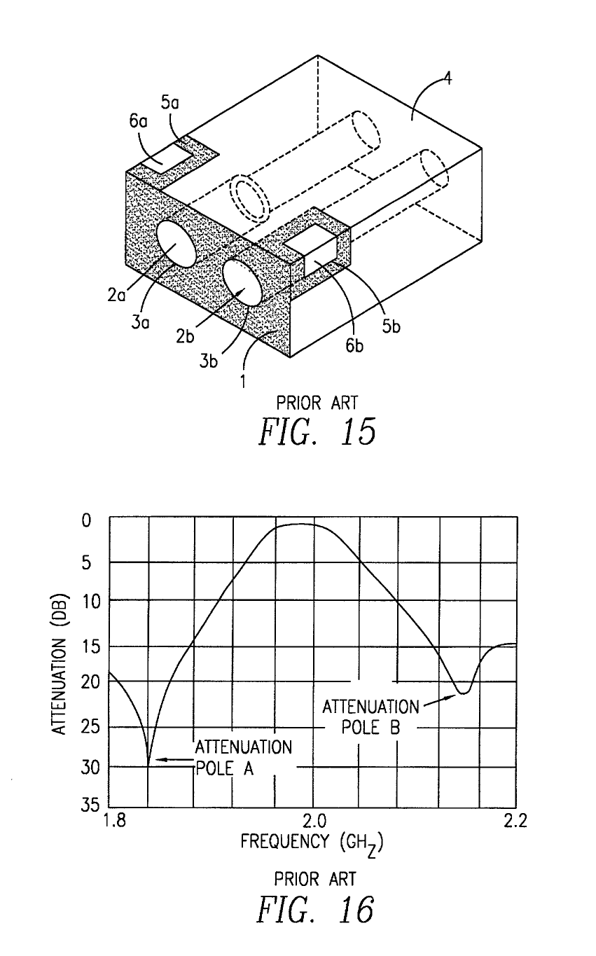

The dielectric duplexer shown in FIG. 13 is made from a single dielectric block 1 in which a dielectric filter having four resonators formed by the resonant cavities defined by the through holes 2a and 2d having internal conductors thereon is provided as a transmission-side filter, a dielectric filter having three resonators formed by the resonant cavities defined by the through holes 2e to 2g having inner conductors thereon is provided as a receiving-side filter, and an input-output electrode which includes the antenna excitation hole 18 is provided there between. An outer conductor 4 is formed on the six outer surfaces of the dielectric block 1. Each of the resonant cavities is open circuited by a respective conductor-less portion formed in the through holes. A narrow conductor-less strip extends from the conductor-less portion 5b defining the input-output electrode 6b. The conductor-less strip extends a predetermined distance in a direction parallel to the axes through holes 2a to 2b to provide a conductor-less rectangular extended portion 7.

With this structure, an attenuation pole in the TE mode can be shifted in each of the transmission-side filter and the receiving-side filter to obtain a desired characteristic.

An input-output electrode may be provided as shown in the embodiments of FIGS. 6 through 12.

The structure of a communication apparatus according to the invention will now be described with reference to FIG. 14.

In FIG. 14, there are shown a transmission and receiving antenna ANT, a duplexer DPX, bandpass filters BPFa and BPFb, amplification circuits AMPa and AMPb, mixers MIXa and MIXb, an oscillator OSC, and a synthesizer SYN. The MIXa modulates a frequency signal output from the SYN by an IF signal, the BPFa passes signals only in a transmission-frequency band, and AMPa applies electric-power amplification to a received signal and transmits it through the DPX from the ANT. The AMPb amplifies signals output from the DPX, and the BPFb passes signals only in the receiving-frequency band among the signals output from the AMPb. The MIXb mixes a frequency signal output from the SYN with a received signal to output an intermediate-frequency signal IF.

Dielectric filters having the structures shown in FIG. 1 to FIG. 3, and FIG. 5 to FIG. 12 can be used as the band-pass filters BPFa and BPFb shown in FIG. 14. The dielectric duplexer shown in FIG. 13 can be used as the dielectric duplexer DPX. By using compact dielectric filters having required attenuation characteristics and a compact dielectric duplexer having a required attenuation characteristic, a compact communication apparatus having a predetermined communication performance is formed.

What is claimed is:

1. A dielectric filter, comprising:
a dielectric block having a plurality of outer surfaces and a plurality of through holes extending through the dielectric block;
inner conductors located on respective inner surfaces of the through holes;
an outer conductor located on a plurality of the outer surfaces of the dielectric block;
an input-output electrode formed on at least one of the outer surfaces of the dielectric block, the input-output electrode being spaced from the outer conductor by a first conductor-less portion; and
a rectangular second conductor-less portion extending from the first conductor-less portion to generate an attenuation pole at a desired frequency positioned at a higher-frequency side of the pass band of a transmission signal.

2. A dielectric filter according to claim 1, wherein the first conductor-less portion surrounds the input-output electrode on at least three sides and includes a straight portion and the second conductor-less portion extends from the straight portion in a direction perpendicular thereto.

3. A dielectric filter according to claim 2, wherein the through holes extend in respective, parallel axial directions and the second conductor-less portion extends parallel to the axial directions of the through holes.

4. A dielectric filter according to claim 2, wherein the through holes extend in respective, parallel axial direction and the second conductor-less portion extends perpendicular to the axial directions of the through holes.

5. A dielectric filter according to claim 1, further comprising a third rectangular conductor-less portion extending from the first conductor-less portion.

6. A dielectric filter according to claim 5, wherein the second and third conductor-less portions extend parallel to one another.

7. A dielectric filter according to claim 5, wherein the second and third conductor-less portions extend perpendicular to one another.

8. A dielectric filter according to claim 1, wherein the through holes extend from a first face of the dielectric block to a second, opposing face of the dielectric block and wherein the outer conductor is not formed on the first face of the dielectric block.

9. A dielectric filter according to claim 1, wherein the outer conductor is located on all of the outer faces of the dielectric block and conductor-less portions are formed on the inner surfaces of the through holes to define open ends of the inner conductors.

10. A dielectric filter according to claim 1, wherein the dielectric block has a parallelepiped shape.

11. A dielectric filter according to claim 10, wherein the through holes extend in respective, parallel axial directions and the dielectric block has a mounting surface extending parallel to the axial directions of the through holes and the input-output electrode is located at least partially on the mounting surface.

12. A dielectric filter according to claim 11, wherein the dielectric block also has two end surfaces extending perpendicular to the mounting surface and parallel to the axial directions of the through holes and the input-output electrode extends partially onto one of the end surfaces.

13. A dielectric filter according to claim 1, wherein the first conductor-less portion includes three contiguous straight portions which at least partially surround the input-output electrode and the second conductor-less portion is connected to and extends perpendicularly from one of the three straight portions.

14. A dielectric filter according to claim 13, further including an arcuate conductor-less portion connected to the second conductor-less portion.

15. A dielectric duplexer formed in a dielectric block having a plurality of outer surfaces, the dielectric duplexer including first and second dielectric filters, at least one of the dielectric filters comprising:
a plurality of through holes extending through the dielectric block;
inner conductors located on respective inner surfaces of the through holes;
an outer conductor located on a plurality of the outer surfaces of the dielectric block;
an input-output electrode formed on at least one of the outer surfaces of the dielectric block, the input-output electrode being spaced from the outer conductor by a first conductor-less portion; and
a rectangular second conductor-less portion extending form the first conductor-less portion to generate an attenuation pole at a desired frequency positioned at a higher-frequency side of the pass band of a transmission signal.

16. A communication apparatus comprising a dielectric duplexer described in claim 15.

17. A communication apparatus comprising a dielectric filter as described in claim 1.
